(19) United States
(12) Patent Application Publication
(10) Pub. No.: US 2007/0072474 A1
(43) Pub. Date: Mar. 29, 2007

(54) Flexible power adapter systems and methods

(76) Inventors: Nigel Beasley, Chesham (GB); Scott C. Smith, Seattle, WA (US)

Correspondence Address: SHEPPARD, MULLIN, RICHTER & HAMPTON LLP, 333 SOUTH HOPE STREET, 48TH FLOOR, LOS ANGELES, CA, 90071-1448, US

(21) Appl. No.: 11/411,448

(22) Filed: Apr. 26, 2006

Related U.S. Application Data
(60) Provisional application No. 60/675,702, filed on Apr. 27, 2005.

(51) Int. Cl. H01R 13/625

(52) U.S. Cl. 439/332

(57) ABSTRACT

A power adapter is provided that includes a base adapter configured to perform power conversion to supply power requirements of an electronic device from a power source. The power adapter converts the power signal from the power source into power signal compatible with the first electronic device. Input and output connectors provide coupling to the power source and electronic device, respectively. An accessory adapter can be provided and can be configured to be removably coupleable to the base adapter for modular operation. The accessory adapter can be configured to provide another power signal to power a second electronic device. Multiple accessory adapters can be added to provide power requirements for multiple devices. Security keys can be used to authenticate the power supply for security and verification purposes.

### BACKGROUND OF THE INVENTION

This application claims the benefit of priority under 35 U.S.C. § 119(e) to U.S. provisional application serial no. 60/675,702 filed on Apr. 27, 2005, the entirety of which is incorporated by reference herein.

### FIELD OF THE INVENTION

The present invention relates generally to power products and more specifically to flexible power devices, systems and methods for powering a plurality of electronic devices.

### DESCRIPTION OF RELATED ART

Our contemporary society enjoys numerous electronic devices that help to make our lives more productive, more comfortable, more enjoyable and more efficient. Such devices include, for example, notebook computers, personal digital assistants (PDAs), cell phones, computer printers, DVD players, DC players, MP3 players, digital cameras, camcorders, and other portable electronic devices.

To enhance portability of such electronic devices, rechargeable batteries, although not required, are often provided. Examples of such rechargeable batteries include, among others, lithium-ion, nickel-metal hydride, and nickel-cadmium. Such rechargeable batteries allow a user to operate the electronic device while away from an AC power source for some period of time before needing to recharge. However, even with a battery source to enhance portability, an occasional or periodic connection to a power source, such as, for example an AC power source, is typically made to either operate the device directly or to recharge the batteries or both.

Unfortunately a number of different mechanical and electrical interfaces are typically required to accommodate the diversity of portable electronic devices and associated batteries that are available to consumers. This can result in a user carrying many different power supplies and battery chargers. This can diminish mobility and convenience, while increasing equipment cost. Also many different power supplies and battery chargers include similar power conditioning circuitry to one another, resulting in the wasteful duplication of electronic components.

### SUMMARY OF THE INVENTION

According to one embodiment, a power adapter is provided that includes a base adapter configured to convert a first power signal from a first power source into second power signal for a first electronic device, an input connector electrically coupled to the base adapter and configured to accept the first power signal from a power source, an output connector electrically coupled to the base adapter and configured to provide the second power signal to the first electronic device, and an accessory adapter removably coupleable to the base adapter and configured to receive one of the first and second power signals from the base adapter and to provide a third power signal to a second electronic device.

In another embodiment, a method for providing power to a plurality of electronic devices, includes accepting a first power signal from a power source, converting the first power signal to a second power signal at a current and voltage level suitable for powering a first electronic device and providing the first power signal to the first electronic device, providing a third power signal to an accessory adapter and the accessory adapter providing a fourth power signal to a second electronic device.

In yet another embodiment, a method for providing power to a plurality of electronic devices, includes connecting a input connector of a power adapter to a power source, connecting an output connector of the power adapter to a first electronic device, connecting an accessory adapter to an electrical interface of the power adapter, and connecting an output connector of the accessory adapter to a second electronic device. The method can further include disconnecting the accessory adapter from the electrical interface, connecting a second accessory adapter to the electrical interface and connecting an output connector of the second accessory adapter to a third electronic device.

A method for securing an electronic device can also be provided. In one embodiment, the method includes supplying power to the electronic device and transmitting a security key to the electronic device, wherein the electronic device is configured to verify the security key before allowing access to the user. Transmitting the security key to the electronic device can be conducted via a wired or wireless communications interface. In another embodiment, a power adapter is configured to provide output power at a connector, and a security key associated with the power supply and configured to control user access to the electronic device.

### BRIEF DESCRIPTION OF THE DRAWINGS

The invention, in accordance with one or more various embodiments, is described in detail herein with reference to the accompanying drawings. The drawings are provided for purposes of illustration only and not limitation. It should be noted that for clarity and ease of illustration these drawings are not necessarily made to scale. Additionally, drawings of a ‘block diagram’ form have been utilized for ease of illustration and understanding, and the various blocks or other representative units are provided to illustrate functionality not necessarily the appearance or architecture of a given item. Thus, the various components, units and other items illustrated may take any suitable form as may be desired or appropriate. Additionally, various figures set forth an example architectural or structural configuration for the example embodiment described with reference thereto. It will be understood by one of ordinary skill in the art after reading this description how to implement the features and functionality described herein with alternative architectures, structures and configurations.

FIG. 1 is a diagram illustrating an example implementation of a base adapter and an accessory adapter in accordance with one embodiment of the invention.

FIG. 2 is a diagram illustrating an embodiment of the invention wherein the accessory adapter is a battery charging adapter in accordance with one embodiment of the invention.

FIG. 3 is a diagram illustrating an accessory adapter implemented as direct accessory adapter in accordance with one embodiment of the invention.

FIG. 4 is a diagram illustrating yet another alternative embodiment of the invention wherein accessory adapter is implemented as an inductive power adapter.

FIG. 5 is a diagram illustrating an example of stackable accessory adapters in accordance with one embodiment of the invention.

FIG. 6 is a diagram illustrating an example of speakers connected to base adapter as an electronic device.

FIG. 7 is a diagram illustrating an example of a modem connected to base adapter as an electronic device.

FIG. 8 is a block diagram illustrating an example implementation of a USB hub connected to a base adapter in accordance with one embodiment of the invention.

FIG. 9 is a block diagram illustrating an example implementation of a wireless power-transfer device with an exemplary electronic device in accordance with one embodiment of the invention.

### DESCRIPTION OF THE PREFERRED EMBODIMENTS

The present invention is directed to systems and methods for powering electronic devices. In one embodiment, a base adapter along with a set of one or more accessory adapters is provided to achieve a multi-purpose power product that can be configured to power one or more of a plurality of different electronic devices. In another embodiment, a wireless power-transfer device is provided to provide power to an electronic device without the need for a physical electrical connection. In yet another embodiment, one or more security keys can be utilized in conjunction with a power product to provide security or authentication with the product or device.

The base adapter, in one embodiment, provides electrical power conversion used to convert AC power to DC power for powering an electronic device (i.e., operating the device and/or charging the battery or batteries of the electronic device). The accessory adapters, in one embodiment, are configured to operate in conjunction with the base adapter and to provide an additional or alternative DC power source to an electronic device. Although the invention is discussed herein in terms of example embodiments wherein power conversion is performed to convert AC (alternating current) power to DC (direct current) power, it will be apparent to one of ordinary skill in the art how to implement the invention in applications where power can be converted from any form to another, including, for example, AC to AC, AC to DC, DC to DC and DC to AC.

In one embodiment, the power conversion is provided exclusively or primarily by the base adapter. The accessory adapter can provide a particular mechanical or physical interface to an electronic device that is typically different from that provided by the base adapter. In embodiments where the power conversion from AC to DC is provided exclusively by the base adapter, the accessory adapter can be implemented so as to simply pass the converted DC current from the base adapter to the electronic device to which it is connected. In such embodiments, the accessory adapter can be implemented to provide additional signal conditioning that may be appropriate for the particular electronic device it is powering. For example, it may provide a voltage conversion to provide the correct signal levels to the electronic device. In other embodiments, power conversion can be provided by the accessory adapter. For example, the base adapter may pass the AC source power to the accessory adapter, with or without some conversion or conditioning, and the accessory adapter performs conversion appropriate for the intended electronic device to be powered.

In another embodiment, multiple adapters can be included to power a plurality of electronic devices along with the base adapter. The multiple accessory adapters can be configured to be interchangeably coupled to or mounted on the base adapter. Additionally, depending on the implementation, the base adapter and accessory adapters can be configured such that a plurality of accessory adapters can be connected to (directly or indirectly, and physically or electrically) one base adapter. For example, the base adapter can have multiple connection points to allow mounting one or a plurality of accessory adapters thereto. Alternatively, the accessory adapters can be configured to be stackable or otherwise connectable to one another to allow a first accessory adapter to be mounted to a base adapter, and one or more accessory adapters mounted to the first accessory adapter and so on.

In the various embodiments, the base adaptor and one or more accessory adaptors can be configured to include various interchangeable tips or connectors to interface to a plurality of power sources and to a plurality of electronic devices. Additionally, switches or other controls as well as a display can be included to allow the user to select the appropriate output power parameters (e.g., voltage, current, frequency, etc.) for a given adapter allow flexibility in configuration. Thus, the combination of interchangeable power tips and configurable power settings can afford ultimate flexibility to the user in configuration of a power package customized or tailored to the user's suite of devices to be powered.

In another embodiment, mechanical or electrical keying can be used to identify a tip or the electronic device, and the keying used to configure the parameters of the one or more adaptors. For an example of an electronic key, an RFID tag can be incorporated with the interchangeable tip or with the electronic device to identify that device or to specify the relevant power parameters. The adaptor can include an RFID reader to sense the electronic key information and other logic (hardware, software, firmware or a combination thereof) to configure the adaptor parameters accordingly. Of course, other memory devices and mechanisms can be used to provide an electronic key along with a wired or wireless interface to the adaptor.

In yet another embodiment of the invention, a wireless power-transfer apparatus is provided wherein one or more portable electronic devices can be powered (e.g., operated and/or charged) by being placed in proximity to the cordless power-transfer device without requiring a physical electrical contact between the wireless power-transfer device and the portable electronic device or devices being powered. In one embodiment, the wireless power-transfer device includes at least one preferably substantially planar surface having one or more electrical conductors disposed near the surface and configured to generate an electromagnetic field when a current is applied and flows through the conductor.

The resultant electromagnetic field can be utilized to generate a current in another conductive element that is placed in proximity to the first conductor. This resultant generated current can be used to operate an electronic device and/or charge the batteries of the electronic device. In this embodiment wherein an inductive electromagnetic field is utilized, the powering can take place without a physical electrical connection between the wireless power-transfer apparatus and the one or more electronic devices being powered.

In one embodiment, intelligence modules are provided with the wireless power-transfer device and with the electronic device in which a current is to be induced, such that intelligent operating parameters can be communicated between the power-transfer device and the electronic device. For example, the power-transfer device can be configured to be inoperable unless an electronic device having an appropriate intelligence module is placed in proximity to the power-transfer device. Additionally, intelligence or other capabilities in the intelligence module can indicate to the power-transfer device the state of charge of the electronic device being charged. For example, when the electronic device has reached a full charge, an appropriate signal can be sent from the electronic device to the power-transfer device via the intelligence module indicating that the charging operation is complete. As a result of this communication, the power-transfer device can then cycle to a non-charging mode or to a lower-level trickle mode so as to minimize power consumption and minimize the risk of damage to the electronic device or its battery.

Additionally, the intelligence module can be implemented so as to allow the system to provide safety features that reduce the risk of unwanted effects from the power-transfer device. For example, if the power-transfer device is operational, that is, power is applied to it and it is generating an electromagnetic field, this field can cause unwanted or undesirable effects. As an example, an unwitting user may place his or her car keys in proximity to the power-transfer device such that they are in the electromagnetic field. Depending on the composition of the keys and the power and frequency of the electromagnetic field, the result could be to increase the temperature of the keys to an undesirably high level. Thus, an unwitting person could pick up the keys, which, unbeknownst to him or her, may be hot enough to cause discomfort or even burns.

However, in embodiments where an intelligence module is utilized to enable the wireless power-transfer device, the wireless power-transfer device can be configured to be in a powered-down state (or at least a reduced-power state) unless an electronic device with a corresponding intelligence module is placed in proximity thereto. Thus, a person placing his or her keys on the wireless power-transfer device will not, by this act alone, cause the device to be activated, and thus will not result in electromagnetically inductive heating of the keys.

It is envisioned that the intelligence modules can communicate between the power-transfer device and the electronic device via wireless signal communication techniques such as, for example, through the use of RFID tags, Bluetooth®, 802.11, 802.16 and other standards, as well as by modulation of the electromagnetic field. In other embodiments, other wireless communication techniques or standards can be utilized to allow communication without physical electrical contact.

In yet another embodiment, hard-wired electrical contacts could be provided to allow the transfer of information between intelligence modules. However, this embodiment is less desirable, as one feature of the device is to allow cordless charging and powering techniques, wherein a physical electrical connection does not need to be made. Thus, in a preferred embodiment, the intelligent module in the power-transfer device is in signal communication with an intelligence module in the electronic device utilizing wireless communication techniques.

In yet another embodiment of the invention, a wireless power-transfer device can be combined with a base adapter to provide cordless-powering techniques for one or more electronic devices. In one embodiment, the wireless power-transfer device can be integrated in or with the base adapter so as to allow the base adapter itself to function as a wireless power-transfer device. This can be in addition to or in place of the traditional corded power output mechanism from the base adapter. For example, a coil or other suitable configuration of electrical conductor can be placed in proximity to a preferably relatively flat surface of the base adapter such that when the base adapter is plugged into an AC power source, an appropriate electromagnetic field is generated to provide suitable current induction in an electronic device or battery charger that is placed in proximity thereto. As would be apparent to one of ordinary skill in the art after reading this description, the surface need not be flat, and indeed can be configured, for example, to conform to the shape of an electronic device to which it is to be mated. Thus, in this embodiment, the base adapter can function as a multi-purpose adapter capable of powering one electronic device by the conventional corded or wired means and another electrical device via the cordless electromagnetic means. Additionally, a base adapter with the wireless power transfer device can also be configured to accept one or more accessory adapters such that a plurality of electronic devices can be powered with varying degrees of flexibility.

Additionally, in yet another embodiment, the wireless power-transfer device can be provided in conjunction with an accessory adapter. In this way, a base adapter (with or without its own wireless power-transfer device) can be configured to receive or otherwise connect to one or more accessory adapters having associated wireless power-transfer device(s), thus enabling that base adapter to function in that capacity. As with other embodiments described above, this wireless power-transfer embodiment can be implemented with a plurality of accessory adapters as well.

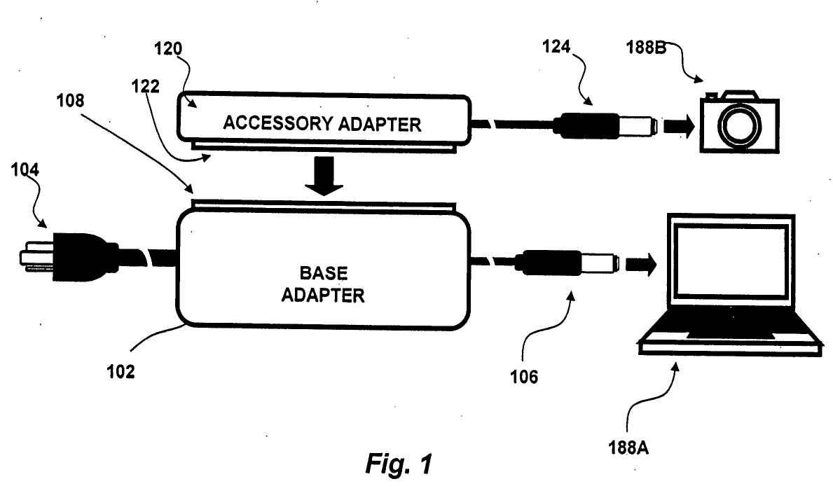

FIG. 1 is a diagram illustrating an example implementation of a base adapter and an accessory adapter in accordance with one embodiment of the invention. Referring now to FIG. 1, in the illustrated embodiment, a base adapter 102 is provided, having a first power cord terminated in a first power plug 104, and a second power cord terminated in a second power plug 106. An electrical interface 108 is also provided to accept one or more accessory adapters 120. Accessory adapter 120 has a corresponding electrical interface 122 that is suitably configured to mate with electrical interface 108 of the base adapter 102 to provide suitable transfer of electrical power or other signals between base adapter 102 and accessory adapter 120. In the embodiment illustrated in FIG. 1, accessory adapter 120 also includes a power cord terminated in a plug 124.

In the embodiment illustrated in FIG. 1, power cord and plug 104 are illustrated as being configured so as to be connected to an AC power source such as, for example, a standard AC wall outlet. Illustrated are a three-prong power plug which provides for the appropriate polarity configuration and a ground prong. The power plug illustrated is a conventional style plug for United States power applications; however, it would be apparent to one of ordinary skill in the art (in this as well as in the other embodiments described herein) how to implement the invention utilizing power cords and plugs of different configurations for power sources conforming to other standards or in other countries or regions.

Additionally, in the embodiment illustrated in FIG. 1, cord and plug 106 are illustrated as a DC power cord and jack suitably configured for electrical connection to one of a plurality of electronic devices such as, for example, the laptop computer 188A illustrated in FIG. 1. Likewise, power cord and plug 124 are also illustrated as a DC power cord and jack suitable for connection to an electronic device which, in this example, is illustrated as being an electronic camera 188B.

Although not illustrated in FIG. 1, a latching or other securing mechanism can be provided with base adapter 102 and accessory adapter 120 to allow the accessory adapter 120 to be fixedly and removably connected to base adapter 102. Thus, a secure connection can be provided, thereby helping to ensure adequate electrical contact between electrical connectors 108 and 122. Additionally, a key, post, or other polarity-type of mechanism can be utilized to ensure that accessory adapter 120 can only be connected to base adapter 102 in the appropriate orientation.

Alternatively, intelligence can be provided to allow accessory adapter 120 to be connected to base adapter 102 in a plurality of differing orientations with the signals redirected to the appropriate pins based on the orientation utilized. Thus, for example, a plurality of connectors can be utilized to enable base adapter 102 to detect the orientation at which accessory adapter 120 is connected (or vice versa). Having sensed the orientation, the appropriate signals can be directed to the correct connectors based on the given orientation. As would be apparent to one of ordinary skill in the art after reading this description, such an intelligence module can be provided by any of a variety of forms of control logic using hardware, software, or a combination thereof. For example, one or more processors, ASICs, PLAs, and other logic devices or components can be included to serve as the appropriate intelligence module.

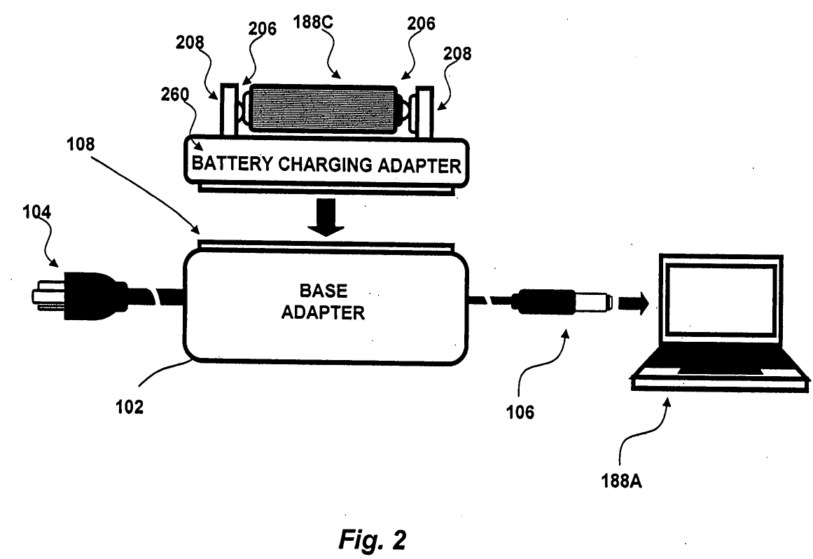

In certain embodiments, accessory adapters 120 of multiple varying configurations can be provided to allow powering of additional electronic devices, or to allow flexibility of configuration. FIG. 2 is a diagram illustrating an embodiment of the invention wherein the accessory adapter is a battery charging adapter in accordance with one embodiment of the invention. Referring now to FIG. 2, accessory adapter 120 is implemented as a battery charging adapter 220. In this embodiment, battery charging adapter 220 can mount to and be in electrical connection with base adapter 102 in a manner similar to that as described with reference to the other embodiments described herein. However, in this embodiment, battery charging adapter 220 includes an appropriate structure to accept or house a rechargeable battery or batteries 188C, and to provide the appropriate electrical current thereto to effectuate charging.

For example, as illustrated in FIG. 2, a housing 206 is provided to create a physical cradle or other structure in which a battery 188C can be placed for charging. Housing 206 also provides, in this embodiment, an appropriate structure utilized to provide a location for fixedly mounting contacts 208 that are used to provide electrical connection to the corresponding contacts of battery 188C. Electrical contacts 208 are made of suitable conductive material such as, for example, copper, silver, alloys of the above, conductive alloys, or other suitable conductive materials as is well known in the art, and can include springing or spring-like mechanisms to allow battery 188C to be inserted and removed easily while still maintaining sufficient pressure for adequate electrical contact.

Although battery 188C is illustrated in FIG. 2 as an AA-cell battery, it will be apparent to one of ordinary skill in the art after reading this description how other batteries of other sizes, shapes, packages, configurations and connection types can be utilized with the invention and how an appropriate housing 206 and configuration of contacts 208 can be utilized to accommodate such alternative battery configurations. Additionally, housing 206 is illustrated as an open housing to facilitate description and to better illustrate this particular embodiment. However, it would be apparent to one of ordinary skill in the art after reading this description how alternative housing configurations can be implemented to better secure battery 186 (regardless of battery type) to the battery charging adapter 220. Additionally, a door, strap, latch, snap, friction mount, or other mechanism can be provided to fixedly secure the battery in place to ensure that it is not inadvertently released from the housing 206.

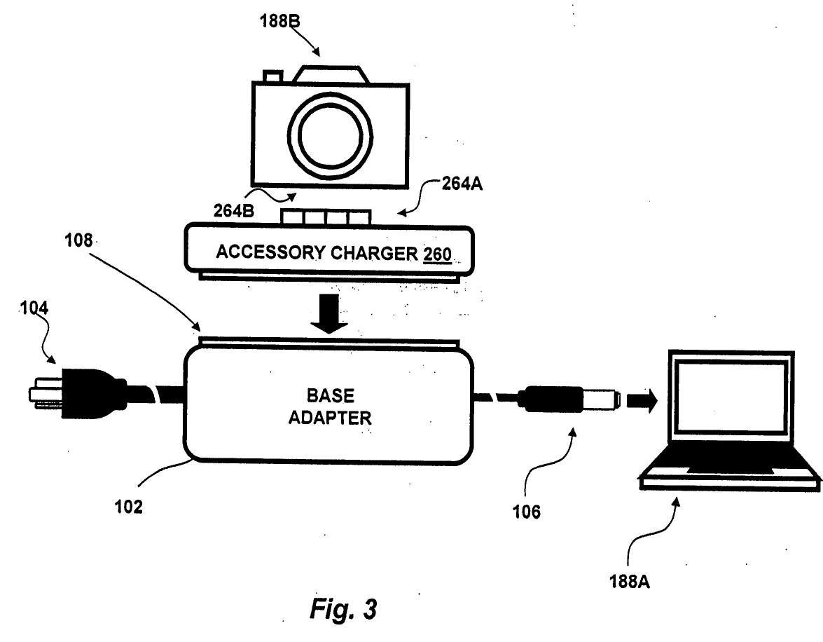

FIG. 3 is a diagram illustrating an accessory adapter 120 implemented as direct accessory adapter in accordance with one embodiment of the invention. Referring now to FIG. 3, an accessory charger 260 is provided to allow electrical connection to and powering of an electronic device, such as the exemplary electronic camera 188B illustrated, without using an attached power cord. In the illustrated embodiment, an accessory charger 260 is provided to interface with base adapter 102 as described in the embodiments illustrated above. However, in this embodiment, accessory charger 260 includes a power connector 264A that mates with a suitable power connector 264B on the electronic device. Thus, the electronic device can be mounted directly to accessory charger 260 such that the appropriate electrical signals can be provided to the electronic device to facilitate charging.

Although the connections 264A 264B are illustrated in FIG. 3 as having a male connection on accessory charger 260 and a female connection on the electronic device, it will be apparent to one of ordinary skill in the art how alternative configurations can be utilized. Additionally, as discussed above with reference to FIGS. 1 and 2, appropriate latching, securing, and orientation techniques can be provided to ensure proper charging and to provide ease of operation.

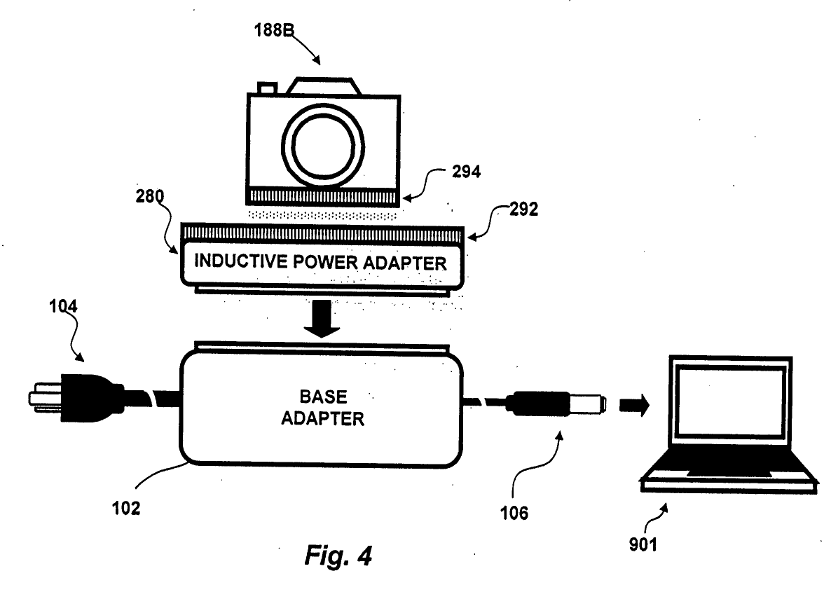

FIG. 4 is a diagram illustrating yet another alternative embodiment of the invention wherein accessory adapter 120 is implemented as an inductive power adapter. Referring now to FIG. 4, in the illustrated embodiment, an inductive power adapter 292 is provided to allow cordless charging of an electronic device such as, for example, an electronic camera 188B, as illustrated. In one embodiment, inductive power adapter 292 is implemented as a wireless power-transfer device, with or without an appropriate intelligence module, as described herein. A wireless power-transfer device is configured to provide an appropriate electromagnetic current to a corresponding conductor in a wireless power-acceptance device 294 associated with the electronic device. Thus, when the electronic device is placed in proximity to the inductive power adapter 292, an electromagnetic field generated by the inductive power adapter 292 induces a current in a conductor or other circuitry in a power-acceptance device 294 so as to provide power for operation of or power to charge the batteries of the electronic device.

Any of the features and capabilities described herein with reference to wireless power-transfer devices can be included with power-transfer device 292 and power-acceptance device 294 to provide enhanced operational abilities as appropriate for the implementation (including, for example, intelligence modules and security keys). Additionally, features and flexibility as described with reference to other embodiments of the accessory adapter can also be included with inductive power adapter 292 as appropriate for a given implementation. For example, a convenient feature of an inductive power adapter 280 is that the electronic device can be simply placed thereon and removed therefrom to effectuate and cease the charging operations. However, in one embodiment, it may be useful to provide a latching or other securing mechanism such that a sensitive electronic device is not inadvertently displaced from the inductive power adapter 280.

Additionally, in one embodiment, additional conductive elements can be provided with inductive power adapter 280 to create a magnetic field suitable for securing the electronic device by magnetic means to the inductive power adapter. Depending on the electronic device utilized, it is not always necessary that this resultant magnetic field be particularly strong. In fact, it may be desirable to have a magnetic field that is simply strong enough to prevent inadvertent displacement of the electronic device from inductive power adapter 280.

As discussed above, in one embodiment, the accessory adapters 120 are configured such that multiple adapters 120 can be utilized with a given base adapter 100. For example, in one embodiment, accessory adapters 120 can be provided in a stackable or other multi-configurable capacity to effectuate this result. In one embodiment, they can be interchangeably applied to allow flexibility in reconfiguration.

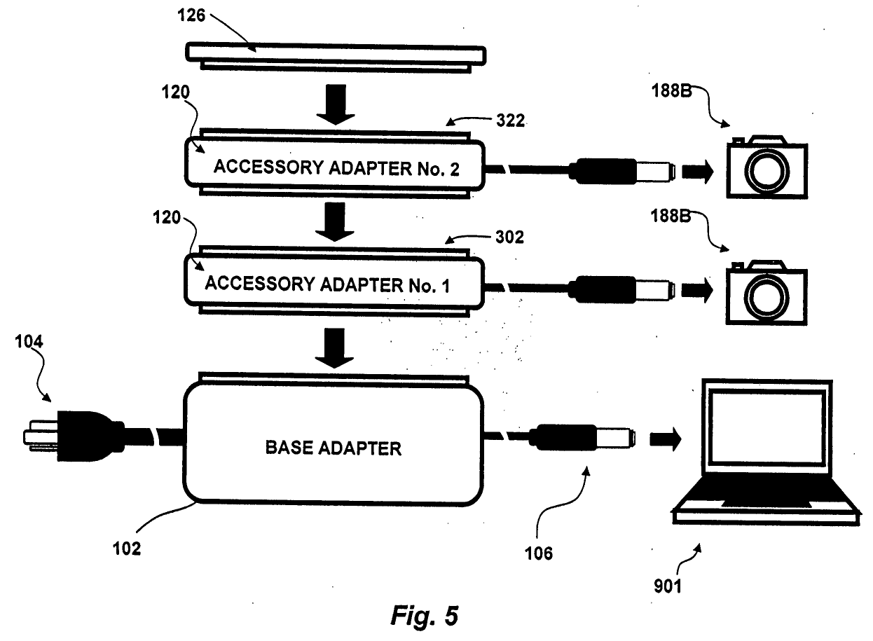

FIG. 5 is a diagram illustrating an example of stackable accessory adapters 120 in accordance with one embodiment of the invention. Referring now to FIG. 5, in the illustrated example, three accessory adapters 120 are illustrated as being electrically connectable to a base adapter 102. In the illustrated embodiment, two corded accessory adapters 120 are provided and illustrated as being stacked upon one another such that they can each power their respective electronic device, which in the illustrated embodiment happens to be an electronic camera 188B. Each of these accessory adapters 120 can include an additional electrical connector 322 to facilitate connection to another accessory adapter 120.

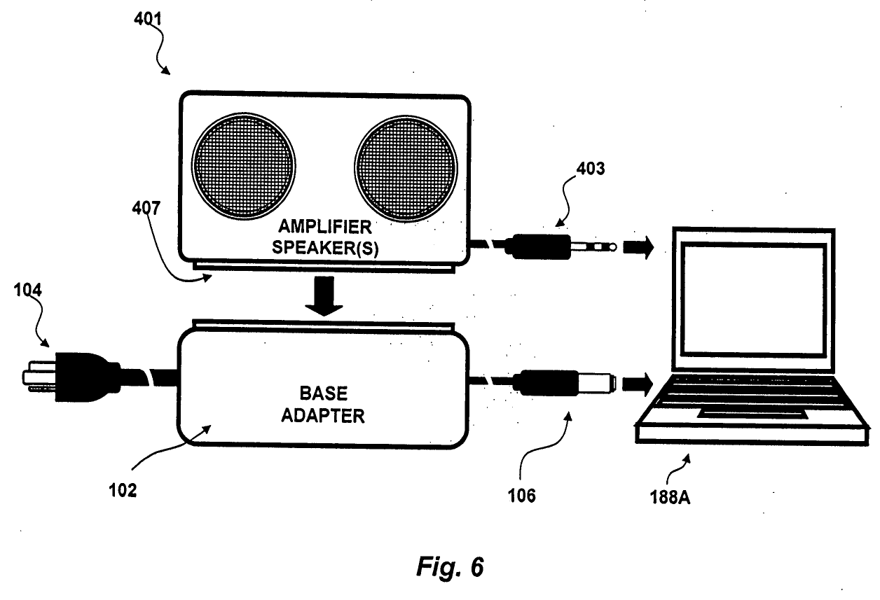

Also illustrated in FIG. 5 is an end cap 126 that can be used to provide a cap or other closure to the electrical connector 322. Thus, removal or replacement of cap 126 can allow the combination to be reconfigured to include fewer or additional accessory adapters 120. As would be apparent to one of ordinary skill in the art after reading this description, the cap 126 illustrated in FIG. 5 can be replaced with any of the other adapters described, including for example the battery charging adapter 220, single accessory adapter 120 (illustrated in FIG. 1), inductive power adapter 280 (illustrated in FIG. 4), or accessory charger 260 (illustrated in FIG. 3), speaker adapter (illustrated in FIG. 6) or other accessory adapters 120 described herein. Thus, this modular approach allows a user to configure his or her charging apparatus to accommodate his or her particular needs. That user can also change the configuration, purchase additional adapters, and generally remove and add adapters as needed to suit his or her changing needs. For example, if a user is taking a trip with a laptop, a cell phone, and a digital camera, the user can choose to take only those modules he or she needs for those devices on the trip to ensure appropriate powering of the devices.

Also, in this and the other embodiments disclosed herein, the user can power multiple devices while only plugging one AC power cord (e.g. 104) into a wall socket. This can be especially beneficial with certain hotel room configurations. If only one socket is available, the user can plug the base adapter in and power one or more devices from the base module itself or from the base module combined with one or more adapters. Additionally, as a further example to illustrate the convenience, the traveler can plug the base module in and without having to plug and unplug additional modules, attach or re-attach various electronic devices for powering and for cordless operation.

In the embodiment illustrated in FIG. 5 as well as in other embodiments, a base adaptor 102 and one or more accessory adaptors 120 can be configured to include various interchangeable tips or connectors to interface to a plurality of power sources and to a plurality of electronic devices. Additionally, switches or other controls as well as a display can be included with an adaptor to allow the user to select the appropriate output power parameters (e.g., voltage, current, frequency, etc.) for a given device to be powered by an adapter 102, 120 to allow flexibility in configuration. Thus, a combination of interchangeable power tips and configurable power settings can afford ultimate flexibility to the user in configuring a power package customized or tailored to the user's suite of devices to be powered.

Additionally, mechanical or electrical keying can be used to identify a tip or to identify the electronic device, and the keying used to configure the parameters of the one or more adaptors. Where a device is identified, a look-up table or other configuration information can be included to allow the adaptor to be configured appropriately for that device or for a device of that class. As an example of an electronic key, an RFID tag can be incorporated or otherwise associated with the interchangeable tip or with the electronic device to identify that tip, to identify a device or to specify one or more relevant power parameters. The adaptor can include an RFID reader to sense the electronic key information and other logic (hardware, software, firmware or a combination thereof) to configure the adaptor parameters accordingly. Of course, alternate memory devices, logic and other mechanisms can be used to provide an electronic key (e.g., parameters and/or identification) along with a wired or wireless interface to provide information to the adaptor.

As an alternative to or in addition to one or more accessory adaptors 120, a battery, fuel cell, capacitive arrangement, solar cell or other portable energy source can be built into an adaptor or configured to detachably connect to base adaptor 102 or to an accessory adaptor 120 to provide power for one or more electronic devices when not connected to a power source such as an AC power line. Thus, the adaptor 102,122 can provide appropriate power to the electronic device (with conditioning by the adaptor as appropriate) without plugging a base adaptor into a wall outlet, for example. In one embodiment, the portable energy source is provided with an electrical interface 122 that mates with the corresponding interface 108, and can be thus attached to base adaptor 102 and can be interchanged as appropriate. In this manner the effective battery life (or unplugged power life) of a laptop or other electronic device can be extended by the use of a portable energy source. Multiple power sources can be provided and ganged together or swapped out to increase available power or to extend the life.

Another alternative embodiment is illustrated in FIG. 6, wherein the electronic device is one or more powered speakers for use in the playback of audio content from an audio device. Referring now to FIG. 6, in this embodiment, a pair of amplified speakers 401 are provided as accessory adapter 120 (or in place of end cap 126 (e.g., connected to electrical connection 322 on an accessory adapter 120)). Thus, the amplified speakers can receive power from base adapter 102 suitable for running the amplifier portion of the setup. Additionally, a cable 403 can be provided to connect to an audio output of the electronic device (which in the illustrated example is a laptop computer 188A) to allow transfer of electrical signals embodying the audio playback material from the electronic device to the speakers 401.

In alternative embodiments, cable 403 can be replaced with a wireless communication channel or with a wired electrical connection of other configuration. Additionally, in some embodiments, the audio content can be modulated onto power signals via cable 105 and demodulated at either base adapter 102 or within the speaker module 401 to provide audio content suitable for playback via the speakers. As will be apparent to one of ordinary skill in the art after reading this description, various features, advantages and capabilities as described above with reference to the other embodiments can be implemented herein where the accessory adapter 120 is a speaker assembly.

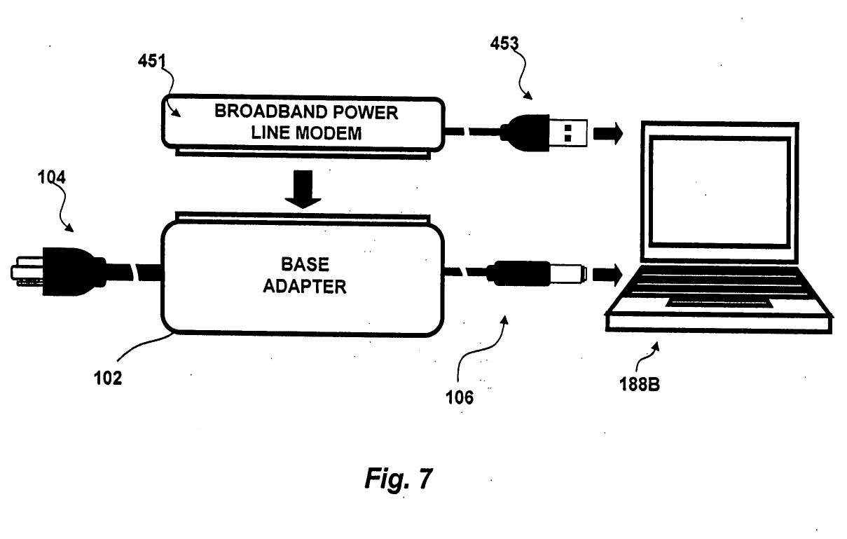

As would be apparent to one of ordinary skill in the art after reading this description, the electronic componentry that can be connected directly to a base adapter 102 is not limited to amplified speakers as described above with reference to FIG. 6. Indeed, numerous electronic devices can be fitted with the appropriate electrical connections to interface to base adapter 102 for providing power or other signals useful to operate or charge the device. For example, the embodiment illustrated in FIG. 7 shows a modem connected to base adapter 102 as an electronic device. As with the speaker embodiment described above, this modem embodiment includes an appropriate signal cable 453 to provide data transfer between the modem 451 and the electronic device. In the embodiment illustrated in FIG. 7, a plug is implemented with a USB connector, which is a suitable connector for interface to a computing device such as a laptop computer 188A. Wireless data connections can be provided as well to enhance the flexibility of the device and for ease of operation. Additionally, power line modulation can be utilized to provide transfer of data and other information between the electronic device and the modem 451 via the power cord 105 106.

Although not illustrated, the modem 451 can also include an appropriate telephone, Ethernet or other connection such that it can be plugged into a correct communications port. Additionally, the modem 451 can include wireless capabilities such as, for example, Bluetooth®, IEEE 802.16 or IEEE 802.11, and the like, to allow the modem to communicate to a network wirelessly. As will be apparent to one of ordinary skill in the art after reading this description, various features, advantages and capabilities as described above with reference to the other embodiments can be implemented herein where the accessory adapter 120 is a modem device.

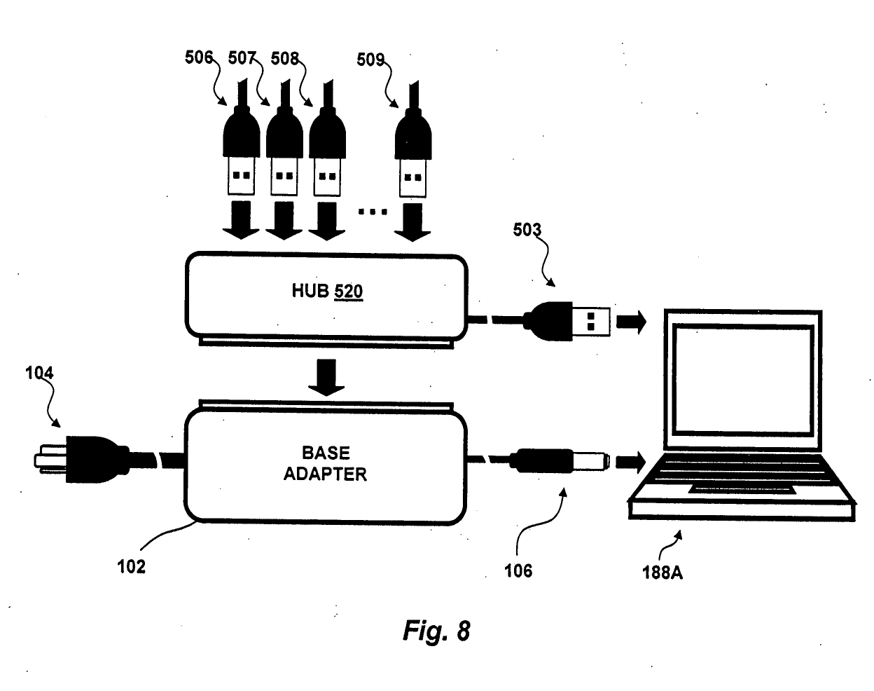

Still another embodiment of the invention includes an implementation of accessory adapter 120 as a multi-port USB hub 501. FIG. 8 is a block diagram illustrating such an implementation in accordance with one embodiment of the invention. Referring now to FIG. 8, a multi-port USB hub 520 is provided in a configuration as an accessory adapter 120. In this embodiment, one or more USB ports can be provided to allow a plurality of USB cables 506-509 to be connected thereto, along with a USB cable 503 to connect to an electronic device such as, for example, the laptop computer 188A. With the appropriate electrical connectivity between hub 520 and base adapter 102, this USB hub 520 can be a powered hub, providing appropriate power to the one or more devices connected thereto. As with the speaker and modem embodiments described above with reference to FIGS. 6 and 7, alternative communication arrangements can be made in addition to or in place of USB cable 503 to allow data and other information to be exchanged between hub 520 and the electronic device.

After reading the description above with reference to FIGS. 6, 7 and 8, it will be apparent to one of ordinary skill in the art how alternative electronic devices can be utilized in addition to or in place of speakers 401, USB hub 520 and modem 451 to provide additional or alternative functionality to a user. For example, a disc drive, card reader, digital camera, cell phone, PDA, iPod, MP3 player or other peripheral or electronic device can be configured so as to be connectable with a base adapter 102 and, thus, suitable to avail itself of the functionality provided thereby. Although these examples are illustrated in FIGS. 6, 7 and 8 as an integrated embodiment wherein the electronic device is incorporated with an accessory adapter 120, an alternative embodiment can be implemented wherein the device is removably connected to an accessory adapter to derive power via a cord or plug (e.g., cord 124 or plug 264 rather than fixedly integrated), inductive interface, or other interface.

Although in some diagrams a USB type of interface is illustrated, alternative data interfaces may be provided utilizing, for example, Ethernet, Firewire, RS-232, or other suitable communication interfaces.

In yet another embodiment of the invention, a security key can be provided to be associated with base adapter 102, one or more accessory adapters 120, or any of the other various components and devices described herein to provide a security key for one or more electronic devices associated therewith. To better illustrate this embodiment, consider a simple example. In this example, a base adapter 102 (with or without electrical connections 108 suitable for accepting an accessory adapter 120) is provided with a security key. The security key is configured to provide a code or other information to an electronic device (for example, a laptop) to which the base adapter 102 is connected. Thus, the electronic device can be configured such that it will not operate without connectivity to a base adapter having the appropriate security key. For example, the security key can contain a particular code, such as a particular data sequence, cipher code, key, digital signature, switch setting or other data code that is used by the electronic device to which it is connected to verify the authenticity of the user (or of the power product) for allowing access to the electronic device.

For example, a power adapter and a laptop computer can be configured with a password or other user code (without or without encryption techniques such as, for example RSA security, and with or without authentication techniques, for example digital signatures) such that the computer will only work with that particular power adapter. Thus, if the user should happen to forget his or her laptop on an airplane or in a coffee shop, or if the laptop should be stolen, the laptop will not work without the appropriate base adapter with the correct security key. Thus, this can provide an additional measure of security to the user's laptop and/or any data stored therein.

As another example, the security coding techniques described herein and their various alternative embodiments can also be applied to an adaptor 102,122, including adaptors described above that have an internal battery, a fuel cell, solar cell, or other energy source. In this example, the security features can provide security for a laptop or other electronic device so that authentication or other security can be provided when the device is disconnected from a wall outlet as well.

Communication used to verify the authenticity of the security key can be made via the power cord between the adapter and the laptop or through a wireless communication channel such as, for example, an RFID tag, a Bluetooth® channel, an 802.11 or 802.16 channel, or other wireless communication channel. Additionally, additional hardwired channels can be provided to effectuate this communication. As would be apparent to one of ordinary skill in the art after reading this description, the security key can be implemented using control logic or other module including hardware, software or a combination thereof.

Where a higher level of security is desired, an embodiment can be implemented wherein the electronic computing device locks, hides, erases, removes, or otherwise destroys or protects any data (or designated data) contained therein if a base adapter is connected to the computer without the appropriate security key. Thus, this can provide a high level of security to mitigate the risk of theft of sensitive data. As would be apparent to one of ordinary skill in the art after reading this description, there are intermediate security measures that can be taken as well without immediately resorting to destruction or removal of all of the data contained in the computing device. For example, different security keys can be provided to allow different levels of access to a device or machine, thus allowing users to share one or more electronic devices and allowing the data, applications, or other functionality or features contained therein to be configured for access or use by those users depending on their security key. Additionally, the system can be configured such that a password, PIN, or other like user-entered security key is utilized in conjunction with the electronic security key to verify the authenticity of the user when connected with the base adapter.

In another embodiment, the electronic device can be configured so that it will not charge internal batteries unless a handshake with the security key is made in the form of exchange of data. This prevents battery charging from a charger that is not equipped with a security key, limiting the usefulness of the electronic device from unauthorized chargers and serving as a theft deterrent. Additionally, the electronic device can be configured so that its functionality if further limited (i.e., beyond battery charging), if a specified time interval between handshakes with the security key has elapsed.

As discussed above, one embodiment of the invention entails a wireless power-transfer device that can be used to provide power to one or more electronic devices 188 for operation of the electronic device 188 or for charging any battery or batteries associated therewith. As would be apparent to one of ordinary skill in the art after reading this description, in embodiments where the electronic device is a battery, the wireless power-transfer device is used to charge the battery itself.

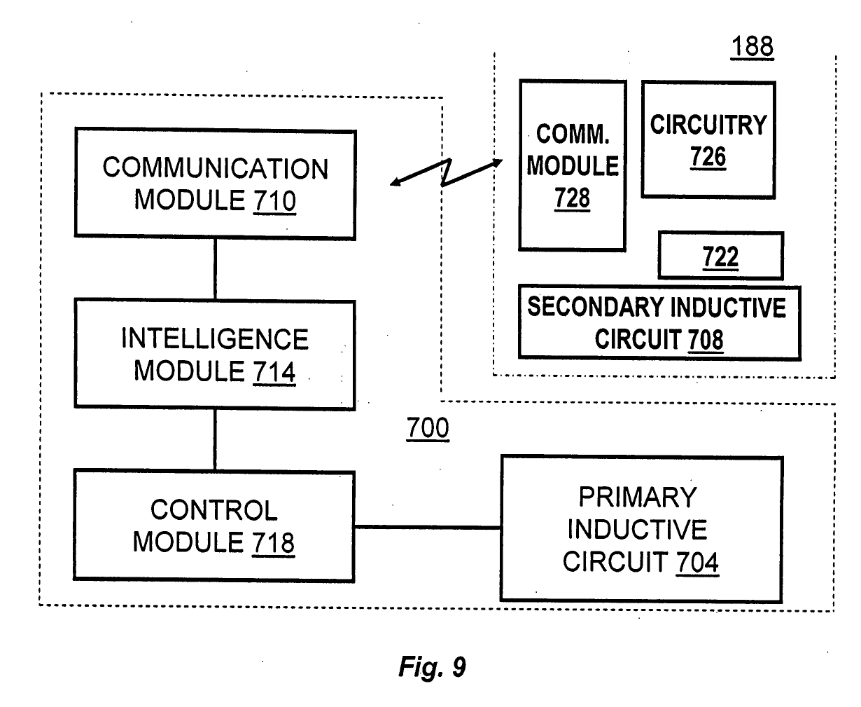

FIG. 9 is a block diagram illustrating an example implementation of a wireless power-transfer device in operational configure with an exemplary electronic device 188 in accordance with one embodiment of the invention. The example embodiment illustrated in FIG. 9 can be utilized as a stand-alone wireless power-transfer device 700 configured to power electronic devices independent of a base adapter 102 or any accessory adapters 120 as may be elsewhere described in this document. Alternatively, the wireless power-transfer device 700 can be utilized in conjunction with a base adapter 102 and one or more accessory adapters 120 in various configurations, one example of which is illustrated above with reference to FIG. 4.

Having thus generally outlined the applicability of a wireless power-transfer device 700 in accordance with the various embodiments of this invention, the example embodiment illustrated in FIG. 9 is now described. The wireless power-transfer device 700 includes a primary inductive circuit 704 that is electromagnetically coupled with a secondary inductive circuit 708 in an electronic device 188 to be powered. The wireless power-transfer device 700 can transfer AC power by inductively coupling conductive elements in primary inductive circuit 704 to corresponding circuit elements in secondary inductive circuit 708. For example, circuitry in primary inductive circuit 704 can include an electrical conductor configured in such a way so as to create an electromagnetic field in response to the application of power (typically in the form of alternating current). This can include, for example, at least one electrical conductor arranged in a coil structure or other configuration such that electromagnetic field lines generated by that conductor can be directed toward locations suitable for placement of an electronic device 188 for charging. Preferably, an active area of the primary inductive circuit is large enough to include an area suitable for placement of one or more electronic devices 188 to be powered. Magnetic, ferromagnetic or other suitable materials can be included with primary inductive circuit 704 to enhance the field generated by the electric current flowing through the electrical circuitry. Such materials can be used, for example, to serve as a flux guide for the electromagnetic field.

In one embodiment, secondary inductive circuit 708 includes at least one electrical conductor suitably configured to generate an electrical current in response to interaction with flux lines of the electromagnetic field generated by the primary inductive circuit 704. In some embodiments, the electrical conductor can be configured in the shape of a coil and wound about a core which can help to concentrate the flux to enhance the operation of the secondary inductive circuit 708. Where a core material is provided, it can be selected having a predetermined level of permeability depending on the application. Although a core material is not always necessary, in some embodiments a high permeability core can be useful to enhance performance.

The conductors in primary inductive circuit 704 can be fashioned from wire, printed strip lines, or other like materials formed in an appropriate configuration (coil or other suitable configuration) to generate an appropriate electromagnetic field. For example, as is known in the art, varying coil configurations or geometries can be utilized to increase the active area of the device, improve the characteristics of the generated field, and allow flexibility in orientation of an electronic device 188 for powering.

In the example embodiment illustrated in FIG. 9, the wireless power-transfer device 700 also includes intelligence capabilities to enhance the functionality and feature set of the device. For example, the embodiment illustrated in FIG. 9 includes a communication module 710, an intelligence module 714, and a control module 718. However, before describing these elements in detail, it is useful to describe an example of an electronic device 188 with which they can operate. Although the wireless power-transfer device 700 can be implemented to operate with any of a number of different electronic devices 188, one example of such an electronic device 188 is also illustrated in FIG. 9. This exemplary electronic device 188 includes a secondary inductive circuit 708 as described above. Also illustrated in the exemplary electronic device 188 are a battery or batteries 722, operational circuitry 726, and a communication module 728.

Battery or batteries 722 can be used to provide operational power to the electronic device 188 for portable or mobile operation, and can also be used to provide power conditioning for operation when connected to a non-portable power supply. Batteries 722 can be implemented in a number of different types, configurations, packages, and compositions, and with a number of different interfaces.

Operational circuitry 726 can vary depending on the type of electronic device 188 provided. For example, in the case of a cellular telephone, operational circuitry can include circuitry for operation of the telephone such as, for example, a baseband chip set, mixed signal circuitry, and radio frequency componentry (e.g., transceivers, power amplifiers etc.) for communication. As would be apparent to one of ordinary skill in the art after reading this description, different operational circuitry can be provided depending on the electronic device 188 being powered.

Communication module 728 is included with the exemplary electronic device 188 to exchange information between electronic device 188 and wireless power-transfer device 700. For example, communication module 728 can be configured to provide to wireless power-transfer device 700 with certain information such as device type, operational and charging power levels, state of charge of one or more batteries 722, and other like information. Communication module 728 can be implemented to obtain some or all of this information from operational circuitry 726 of the electronic device 188 or, in alternate embodiments, can be implemented to produce this information based on signals received by other components of electronic device 188. For example, communication module 728 can be implemented to pass through information obtained from operational circuitry 726 or, alternatively, communication module 728 can be provided with the functionality to determine the state of charge of the batteries based on electronic signals received from the batteries 722 themselves.

In a preferred embodiment, communication module 728 communicates with communication module 710 via a wireless communication channel. Such a wireless communication channel can be implemented utilizing a number of wireless techniques including, for example, RFID tags, Bluetooth®, 802.11, 802.16, as well as any of a variety of wireless communication techniques. Additionally, a hardwired interface can be provided, but may be less desirable as a physical connection may deter from the attractiveness of a wireless power-transfer device 700. Further, in one embodiment modulation techniques can be implemented to modulate information onto the electromagnetic field and detectors provided to receive and demodulate the information from the field.

Communication module 710 provides information received from communication module 728 to an intelligence module 714 that utilizes this information to determine the operational state of the wireless power-transfer device. Intelligence module 714 can be configured to direct a control module 718 to control the power provided to primary inductive circuit 704 or otherwise control the operation of primary inductive circuit 704. For example, capability in the electronic device 188 may determine that its batteries 722 have reached a fully-charged state. As such, communication module 728 would send a signal to communication module 710, which would ultimately inform intelligence module 714 that the batteries 722 are fully charged. In response, intelligence module 714 would direct control module 718 to cease the charging operation.

For example, intelligence module 714 may direct control module 718 to terminate the supply of power to the primary inductive circuit 704, thus terminating the charging operation. Continuing with this example, the state of batteries 722 can continue to be monitored such that should they decline from a fully-charged state, a signal indicating such is likewise communicated to intelligence module 714 (via communication module 728 and communication module 710) and control module 718 can be directed to once again provide power to the primary inductive circuit 704 to continue or resume the charging operation. Additionally, intelligence module 728 can be implemented to cause the operation of secondary inductive circuit 708 to be altered or to otherwise alter or halt the powering of the electronic device 188 with or without communication to the wireless power-transfer device 700.

Likewise, additional or alternative information can be communicated to the wireless power-transfer device 700 to control the operation thereof. Examples of additional information that can be communicated to the wireless power-transfer device include information such as the type of electronic device 188, power requirements for electronic device 188 (for operation or charging), and information pertaining to the type or configuration of the secondary inductive circuit 708. This information can be used to control the operational parameters of primary inductive circuit 704 to tailor its operation to the particular electronic device 188 being charged thereon.

Additionally, with the use of anti-collision techniques with RFID tags and other like communication techniques in alternative embodiments, multiple electronic devices 188 can be charged and information pertaining to each such device can be shared with wireless power-transfer device 700 simultaneously or nearly simultaneously. RFID tags in this and other embodiments can be implemented as active or passive RFID tags. For example depending on the functionality desired, it may be more cost effective to implement communication module 728 as a passive RFID tag that can be read by communication module 710 implemented as an RFID reader.

Although the corresponding circuitry (e.g., secondary inductive circuit 708 and communication module 728) are illustrated in the example embodiment of FIG. 9 as being integrated with an exemplary electronic device 188, this functionality can be included in an accessory adapter 120, for example in place of its physical electrical contacts 122. Thus, electronic devices 188 that do not have inductive charging capabilities can be “converted” to such capabilities by use of an appropriate accessory adapter 120 configured to include the useful inductive circuitry 708, and optionally a communication module 728.

In the embodiments described in this document, a wireless power-transfer device 700 is disclosed as being integrated with a base adapter or an accessory adapter. However, as discussed above, the wireless power-transfer device 700 can be implemented as a stand-alone device as well. For example, it can be implemented as a relatively flat pad, plate or other structure that can be set on a desk or tabletop to provide a surface to accept various electronic devices 188. It can be implemented or integrated with other devices or apparatuses that may already be present in a location where a user typically charges devices. For example, it can be integrated with a mousepad, a notebook cover, a docking station or cradle, or any other device or apparatus that can be configured to accept the inductive circuitry and any control features that may be included therewith.

In certain embodiments, a wireless power-transfer device 700 is configured as having a relatively planar surface on which to place an electronic device 188 for charging and/or operation. However, in alternative embodiments, a wireless power-transfer device 700 can have a shape designed or molded to conform to the form factor of one or more electronic devices 188 to be powered to provide a more secure mechanism for the electronic device.

Security features can be provided with the wireless power-transfer device 700 as well. For example, discussed above is the feature of disabling operation of the wireless power-transfer device 700 in the absence of a suitable electronic device 188 to be powered. Thus, in the above-described embodiments, a wireless power transfer device 700 can be implemented so as to not generate an electromagnetic field until it senses the presence of an electronic device 188 for charging. This sensing can be provided via communications between communication module 728 and communication module 710 indicating that a properly configured electronic device 188 is in the presence of the wireless power-transfer device 700.

Apart from this “physical” security, electronic security can also be provided. Thus, for example, a security key can be provided for operation with an electronic device 188 and a wireless power-transfer device 700 such that the electronic device 188 will not accept a charge unless the appropriate security keys are present. The security mechanisms can be properly integrated with an electronic device 188 such that they cannot be bypassed, thus effectively preventing a thief or other unauthorized user from recharging the device or otherwise providing operational power to the device. For example, the wireless power-transfer device 700 can be configured with a particular digital signature to authenticate that wireless power-transfer device 700 as an authorized charging station. Unless the electronic device 188 receives and verifies the correct digital signature from the wireless power-transfer device, its charging or operational power activities can be disabled. These embodiments are not limited to digital signatures, as other verification and authentication techniques can be provided, including passwords and PINs, as well as public keys, private keys, and other cryptographic techniques.

In one embodiment, a user can program a wireless power-transfer device 700 with the appropriate security key such that it will be recognized by that user's various electronic devices 188. For example, in one embodiment, intelligence module 714 can be configured to accept programming of a security key via communication module 710. This can be done, for example, via wireless communication from the user's computer, cell phone, or other electronic device. Security mechanisms can be established to allow programming to be performed by authorized or verified users to enhance the security features of these embodiments.

Various embodiments of the invention and implementation examples have been described above. However, it is understood that these various embodiments and examples are exemplary only and should not serve to limit the scope of the invention. It is also readily understood by those of ordinary skill in the art how to design and implement the disclosed embodiments using alternate architectures, processes, functionality, structures, and implementations. In sum, after reading this description, various modifications of and alternatives to the preferred embodiments described above can be implemented by those of ordinary skill in the art, without undue experimentation. These various modifications and alternatives are contemplated to be within the spirit and scope of the invention.

As an example of such modifications and alternatives and without limiting the generality of the foregoing, it will become apparent to one of ordinary skill in the art after reading this description, the power cords, plugs and jacks illustrated and described with reference to this the figures and other embodiments in this document can be implemented utilizing a variety of different cords, plugs, jacks or other connectors as may be appropriate for the given application. Thus, a base adapter and accessory adapters can be implemented utilizing any of a number of different power cord and plug combinations appropriate for the given application. Thus, for example, in addition to the AC to DC applications described with respect to FIG. 1 and the other figures and other embodiments, the invention can be implemented in, for example, DC to DC, DC to AC, and AC to AC applications with the appropriate signal conversion and conditioning and with the appropriate cords, plugs, and/or jacks selected for the given application.

Additionally, although a laptop computer 188A, an electronic camera 188B and a battery 188C, speakers 401, modem 451, USB hub 520, and a cell phone (FIG. 9) are illustrated or discussed as primary examples of the electronic devices 188 being powered, it would be apparent to one of ordinary skill in the art after reading this description how these and the other electronic devices illustrated in the figures can be substituted or augmented with alternative electronic devices (including electronic devices, apparatus and equipment, as well as batteries, battery packs, batter modules, fuel cells, and other power packs or power modules, or combinations thereof) to be powered for operation or charging purposes. Indeed, the term electronic devices should not be construed to be limited in scope to the particular exemplary electronic devices described in this document, but should be read to include any device suitable for being powered in the manner discussed herein.

As a further example of such modifications and alternatives, the example embodiments described herein illustrate a configuration for vertically stacking adapters and accessories on top of a base adapter that has an AC connection. As will be apparent to one of ordinary skill in the art after reading this disclosure, stacking accessories on top of a base adapter is not the only way to electrically and mechanically mate the devices. For example, side-by-side arrangements, attachments to multiple sides of the base adapter, and other variations could be implemented work equivalently. Additionally, electrical connectors 108 and 122 are illustrated and described in various embodiments as being in proximity to their respective units such that a base adaptor 102 is mated in close proximity to an accessory adapter 120. However, in addition to an inductive interface as also described, a cable or other like flexible connection can be provided such that the units are not so mated to one another.

As still a further example, in the various embodiments, feedback in the form of electrical signals can be provided from the electronic device to the accessory adapter or base adapter (directly or indirectly) to provide feedback regarding the status of the powering or charging operation. This feedback can be in the form of wired or wireless communication. Thus, features can be provided to control the charging operation and feedback can be utilized in applying such control. For example, the feedback can be used to provide information to a display or other indicator indicating the amount of charge on the battery or batteries. As further examples, feedback can be utilized to cease or reduce the charging operation when the batteries are full, or to completely discharge batteries prior to recharging.

As another example, in FIG. 4, the inductive power coupling interface 243 is shown integrated with inductive power adapter 251. Alternately, the power coupling interface 243 and the inductive power adapter 251 could be disposed in separate mechanical housings that are connected by a power cable or other power coupling.

As yet another example, in FIG. 2 the battery charger adapter 201 may not be integrated with battery charger contacts 202 and 203. Instead, contacts 202 and 203 may be in a separate housing that is connected with battery charger adapter 201 with a power cable.

The term “accessory adapter” with the reference character 120 is used herein to refer not only to the specific accessory adapter 120 (for example, as illustrated in FIG. 1), but also to refer to any of the various alternative embodiments of the accessory adapter 120 as may be illustrated in FIGS. 2 through 8 and as otherwise may be described throughout this document. Although not illustrated in FIG. 9, secondary inductive circuit 708 can be used to provide appropriate levels of current to one or more batteries 722 or directly to operational circuitry 726. Also not illustrated in any power conditioning circuitry that may be included to appropriately condition any power signals provided to batteries 722 or operational circuitry 726. Also not illustrated in FIG. 9 is a power source for the wireless power-transfer device utilized to provide power to the primary inductive circuit 704 (for generation of the electromagnetic field) and to provide appropriate power to the communication module 710, intelligence module 714, and control module 718 as appropriate.

As used herein, the terms “module” and “circuitry” are used to generally refer to the functionality described with respect to each of the respective modules or circuits as applicable and should not be construed as limiting a particular module or circuit. The modules or circuits can be implemented using componentry, hardware, software, firmware, or any combination thereof as may be appropriate for a particular module or circuit. For example, an intelligence module can be implemented utilizing a simple state machine, an ASIC, a processor with associated software, or utilizing any of a number of alternative suitable implementations.

The present invention's flexibility to power electronic devices arises from the myriad of ways that a base adapter can be combined with one or more accessories or chargers. The few permutations of configurations depicted in this disclosure can be readily extended and expanded by one of ordinary skill in the art, without undue experimentation. These various further configurations are contemplated to be within the spirit and scope of the invention.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but can be implemented using a variety of alternative architectures and configurations. Additionally, although the invention is described above in terms of various exemplary embodiments and implementations, it should be understood that the various features and functionality described in one or more of the individual embodiments are not limited in their applicability to the particular embodiment with which they are described, but instead can be applied, alone or in some combination, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed across multiple locations.

What is claimed is:

1. A power adapter, comprising:
a base adapter configured to convert a first power signal from a first power source into second power signal for a first electronic device;
an input connector electrically coupled to the base adapter and configured to accept the first power signal from a power source;
an output connector electrically coupled to the base adapter and configured to provide the second power signal to the first electronic device; and
an accessory adapter removably coupleable to the base adapter and configured to receive one of the first and second power signals from the base adapter and to provide a third power signal to a second electronic device.

2. The power adapter of claim 1, wherein said accessory adapter is configured to pass the received power signal to the second electronic device.

3. The power adapter of claim 1, wherein said accessory adapter is configured to convert the received power signal for transmission to the second electronic device.

4. The power adapter of claim 1, wherein said accessory adapter is removably connected to the second electronic device.

5. The power adapter of claim 1, wherein the second electronic device is integrated with the accessory adapter.

6. The power adapter of claim 1, wherein said accessory adapter is at least one of a power converter, a battery charging adapter, an accessory charger, and an inductive power adapter.

7. The power adapter of claim 1, wherein the accessory adapter further comprises an electrical connection adapted to receive a second accessory adapter.

8. The power adapter of claim 1, wherein the base adapter further comprises multiple connection points configured to accept a plurality of accessory adapters.

9. The power adapter of claim 1, wherein at least one of the first and second connectors comprise interchangeable connectors.

10. The power adapter of claim 1, further comprising a wireless power-transfer device connected to the base adapter.

11. The power adapter of claim 1, wherein the base adapter further comprises a plurality of electrical connectors configured to detect the orientation of the accessory adapter and control logic configured to direct signals to designated pins based on the detected orientation.

12. The power adapter of claim 1, wherein the accessory adapter is a stackable accessory adapter.

13. The power adapter of claim 12, further comprising a second accessory adapter electrically connected to the stackable accessory adapter.

14. The power adapter of claim 12, further comprising an end cap affixed to the stackable accessory adapter.

15. The power adapter of claim 1, wherein at least one of the base adapter and the accessory adapter are programmable power adapters.

16. A method for providing power to a plurality of electronic devices, comprising:
accepting a first power signal from a power source;
converting the first power signal to a second power signal at a current and voltage level suitable for powering a first electronic device and providing the first power signal to the first electronic device;
providing a third power signal to an accessory adapter; and
the accessory adapter providing a fourth power signal to a second electronic device.

17. The method of claim 16, wherein the accessory adapter converts the third power signal to at least one of a different voltage and current to create the fourth power signal.

18. A method for providing power to a plurality of electronic devices, comprising:
connecting a input connector of a power adapter to a power source;
connecting an output connector of the power adapter to a first electronic device;
connecting an accessory adapter to an electrical interface of the power adapter; and
connecting an output connector of the accessory adapter to a second electronic device.

19. The method of claim 18, further comprising the steps of disconnecting the accessory adapter from the electrical interface, connecting a second accessory adapter to the electrical interface and connecting an output connector of the second accessory adapter to a third electronic device.

20. A method for securing an electronic device, comprising the steps of supplying power to the electronic device and transmitting a security key to the electronic device, wherein the electronic device is configured to verify the security key before allowing access to the user.

21. The method of claim 20, wherein the step of transmitting the security key to the electronic device is conducted via a wired or wireless communications interface.

22. The method of claim 20, wherein the electronic device uses the security key to determine the authenticity of the user.

23. The method of claim 20, wherein the security key comprises at least one of a data sequence, cipher code, key, password, and digital signature.

24. The method of claim 20, wherein the electronic device protects data contained therein if a correct security key is not supplied.

25. A power adapter, comprising:
a power supply having an input connector, an output connector and an electrical interface;
an accessory adapter coupled to the electrical interface; and
an output connector coupled to the accessory adapter.

26. A power adapter comprising:
a housing;
a power supply configured to provide output power at a connector;
a security key associated with the power supply and configured to control user access to the electronic device.

27. The power adapter of claim 26, wherein the security key comprises at least one of a data sequence, cipher code, key, password, and digital signature.
